(19) United States
(12) Patent Application Publication
(10) Pub. No.: US 2022/0402446 A1
(43) Pub. Date: Dec. 22, 2022

(54) A COMPOSITE UNDER VEHICLE PROTECTION

(71) Applicant: PIMSA OTOMOTIV ANONIM SIRKETI, Çayirova, Kocaeli (TR)

(72) Inventor: Emre INCEKARA, Çayirova, Kocaeli (TR)

(21) Appl. No.: 17/625,189

(22) PCT Filed: Nov. 3, 2020
(86) PCT No.: PCT/TR2020/051030

§ 371 Date: Jan. 6, 2022

(30) Foreign Application Priority Data
Dec. 30, 2019 (TR) 2019/22425

(51) Int. Cl. B60R 13/08

(52) U.S. Cl. CPC B60R 13/08

(57) ABSTRACT

Disclosed is a rigid and monolithic composite under-vehicle protector containing phenolic felt and a polyurethane material applied by spraying on the phenolic felt. A production method for the under vehicle protector is also disclosed.

### TECHNICAL FIELD

The invention relates to under-vehicle protection placed on the bottom of vehicles in the automotive industry.

In particular, the invention relates to underbody protection comprising of a low-density composite structure to protect the underbody of automobiles, trucks, tractors, etc., to provide sound and impact insulation and to create resistance against chemicals.

### PRIOR ART

All land vehicles in the automotive industry are configured to have a certain endurance to certain road and driving conditions. Increasing this endurance is also being developed with some additional protective components in the vehicles. One of these components is underbody protection. Under vehicle protectors are basically positioned to cover the bottom base of the vehicle and provide protection of the underbody components against sound, impact and various chemicals.

It is important for the endurance of the vehicle to protect the underbody of the vehicle from pieces such as stones and gravel that can create impact when hit. The transfer of sound from the outside into the vehicle is disturbing for both the passenger and the driver, and causes fatigue and distraction on the long road and even creates the risk of accidents. For this reason, providing sound isolation is of great importance for vehicles. In addition, in terms of renewed regulations and safety expectations, the importance of materials with high fire resistance in vehicles has also increased. In addition to these, following the developments in technology in today's world, lightness is also important in vehicles, and the materials used are expected to be light, economical and practical in production (single-process production) and in use (easy to remove and plug in). In line with these developments and demands, under-vehicle protections are required to have high noise, impact and chemical resistance and also to have low density structures. However, there is no existing product that is lightweight, can provide both sound and impact insulation, is resistant to chemicals, has non-flammability feature and can be produced and used in one piece.

The application numbered TR201911897 refers to a composite piece that covers and protects the underbody of the vehicle and/or engine compartment as a whole or part for use in motor vehicles. The said composite part of the invention is a single layer structure consisting of bicomponent polyester fiber and recycled polyester fiber and/or original polyester fiber to protect against impacts caused by heat and external factors. Although the structure is lightweight, it is only resistant to heat and impact.

The application numbered TR201710936 relates to the coating component for the vehicle base area. The coating element includes a layer of cover facing the luggage section, an acoustic foam layer facing the vehicle body, and a heavy layer of polypropylene, which is organized between the acoustic foam layer and the heavy layer, as well as between a carrier layer, the cover layer, and the acoustic foam layer, and is basically used to provide acoustic insulation and is comprises of too many components as a structure and thus offers a heavy structure.

The application numbered TR201415311, a composite insulation board is mentioned. Insulation board is formed by combining materials with different properties that provide heat and sound insulation between indoor and outdoor environment in vehicles. The composite structure is multi-component one, contains very heavy components and provides only heat and sound insulation.

The application numbered EP1986833 (A1) refers to a lightweight, sound-insulating covering for motor vehicles. A lightweight, sound-insulating covering for a body part of a motor vehicle is produced as a foamed, sound-absorbing moulded part in a single-stage operation by injection of a reaction mixture, which contains polyol and isocyanate. The foamed molded part has an integral, essentially pore-free skin with a thickness of at least 0.5 mm on one side and an open-pore surface and/or a thinner, sound-permeable skin on its side opposite said skin.

The application numbered US2010108437 (A1) refers to an acoustic protective panel for vehicles. The said acoustic protective panel consists of an upper porous layer with a flexible polyurethane base, at least one zone of the porous layer being arranged on one sealing layer, in particular with a felt or remelted flexible foam base and one backing layer.

In the applications given above and similar applications, there are structures with at least two components, which are mostly used for protection and sound insulation purposes. In order for these structures to be lightweight, various fiber reinforcements are used. However, in addition to being lightweight, there is no structure that can be easily assembled, and also providing high sound and impact insulation, resistance to chemicals, and fire resistance properties at the same time.

As a result, due to the above-mentioned drawbacks and the inadequacy of the existing solutions, an improvement in the technical field has been required.

### BRIEF DESCRIPTION OF THE INVENTION

The present invention relates to an under vehicle protector used in the underbody of land vehicles that meets the above-mentioned requirements, eliminates all disadvantages and brings some additional advantages.

The primary purpose of the invention is to introduce an under-vehicle protection that offers a low-density configuration compared to its counterparts in order to provide sound and impact isolation on the vehicle underbody, to make it resistant to chemicals and have fire resistance.

Another purpose of the invention is to provide one-piece under-vehicle protection that can be easily mounted to, attached to, and removed from the vehicle and that is replaceable.

Another purpose of the invention is to provide an under-vehicle protection that can be produced in a single process.

Another purpose of the invention is to introduce low-cost under-vehicle protection with minimal component use.

In order to fulfill the objectives described above, the invention relates to a composite under-vehicle protection with phenolic felt content. Accordingly, the said under-vehicle protection contains a polyurethane material which is applied by spraying on the said phenolic felt so as to form the said composite structure as rigid and integral.

In order to achieve the objectives of the invention, the said polyurethane material contains a filling material preferably consisting of at least one of calcite, barite, and zeolite.

In order to achieve the objectives of the invention, the use ratio of phenolic felt in the said composite structure is between 60-90% and preferably 75%.

In order to achieve the objectives of the invention, the use ratio of polyurethane in the said composite structure is between 10-40% and preferably 25%.

In order to achieve the objectives of the invention, the use ratio of at least one of the mentioned calcite, barite, and zeolite is between 5-35% of the said polyurethane content and preferably 5%.

In order to fulfill the objectives described above, the invention is also a production method for the composite structured under-vehicle protection using phenolic felt which is cut in appropriate sizes and placed in the shaping molds. Accordingly, the said production method contains the following process steps.
a) Spraying polyurethane material without filling material or by adding calcite, barite, and zeolite filling materials to create a homogeneous distribution on the phenolic felt surface placed in forming molds,
b) Shaping/forming the sprayed polyurethane material and phenolic felt under temperature and pressure in press molds to provide a composite structure which is rigid and integral,
c) Removing the formed composite structure from the molds and resting it

In order to achieve the objectives of the method of the invention, the temperature of the press mold in the said step (b) is preferably between 60-200° C.

In order to achieve the objectives of the method of the invention, the pressure in the press mold in the said step (b) is preferably applied as 250-450 tons for 30 seconds to 5 minutes.

In order to achieve the objectives of the method of the invention, the resting process in the said step (c) is preferably performed for 3 to 12 hours.

The structural and characteristic features and all advantages of the invention outlined in the drawings below and in the detailed description made by referring these figures will be understood clearly, therefore the evaluation should be made by taking these figures and detailed explanations into consideration.

### DETAILED DESCRIPTION OF THE INVENTION

In this detailed description, the composite under-vehicle protection of the invention is explained only for a better understanding of the subject matter and without any restrictive effect.

The under vehicle protection of the invention is adapted to the vehicle so as to cover the vehicle underbody. Offering a lightweight composite structure, the under-vehicle protection provides sound and impact insulation, chemical resistance and fire resistance. The under-vehicle protection consists of felt and polyurethane material, which are combined to form a composite structure.

Felts are materials that can be produced for a wide variety of purposes and in a various ways according to the needs in many industries. It is especially used in various areas in providing sound and impact insulation. Phenolic and thermoplastic derived felts with binding material in them gain a more rigid structure and become more resistant to impact as a result of melting the binder inside them under temperature. Due to these features, phenolic felt has been preferred as the main component of under-vehicle protection structure. Thermoplastic felt or epoxy felt can also be used instead of phenolic felt in alternative embodiments of the invention. The use ratio of the phenolic felt in the composite structure, which forms the under-vehicle protection, is between 60-90% and preferably 75%.

Polyurethanes are one of the most important materials used in the automotive industry. It can be produced in various density, hardness, and shapes according to the needs. They are produced according to the purpose of use by making formulation changes and various additive-filler additions. Polyurethane is mainly used in the production of sound and impact absorbing parts in the automotive industry. Because of these features, MDI-type polyether-based polyurethane was preferred in the under-vehicle protection of the invention. The use ratio of the polyurethane in the composite structure, which forms the under-vehicle protection, is between 10-40% and preferably 25%.

In order to provide the necessary hardness and low porosity in polyurethane in the composite structure, the filling material can also be added in different proportions. Calcite, barite and zeolite are preferably used as the said filling material. The said filling materials can be added separately, in binary groups, or together in polyurethane. The total use ratio of calcite, barite, and zeolite is between 5-35% and preferably 5% of polyurethane content.

Obtaining the under-vehicle protection composite structure of the invention is carried out with the following process steps;

A. Cutting the felt in sizes appropriate for the area of use

B. Placement of the cut felt in the forming mold

C. Application of polyurethane on felt

It is sprayed on the felt without polyurethane filling material to be applied or by adding calcite, barite and zeolite filling materials. The spraying process is carried out with the spray polyurethane machine to ensure uniform distribution on the entire felt surface. The polyurethane material applied by spray method swells very little compared to other production methods. Polyurethane, which is sprayed on the felt by spray method, acts as resin on the surface and adheres to the felt. In addition, it infiltrates the pores of the felt, providing a more robust structure after curing.

D. Shaping/forming the felt that is sprayed with polyurethane

The polyurethane-sprayed felt is preferably placed in a press mold at a temperature of 60-200° C. and is preferably shaped (cured) under a pressure of 250-450 tons for a period of 30 sec to 5 min. The cured material is removed from the mold and preferably rested for 3 to 12 hours and get ready for assembly. During the forming phase, polyurethane material infiltrates into the felt. The density and pore structure of the felt used here, which will allow polyurethane to leak into the felt, is an important factor in selecting the phenolic felt. The composite structure becomes rigid with the activation of the binder in the phenolic felt under the effect of the temperature during the curing process and the polyurethane infiltrating into the felt. Therefore, the resulting under-vehicle protection has sound, impact and chemical insulation properties and is also a lightweight monolithic part.

The under-vehicle protection of the invention is shaped in one step and obtained with a very fast production process. The resulting under-vehicle protection comfortably meet the lightness feature, which is one of the most important elements needed in today's vehicles, with polyurethane and phenolic felt in its structure. At the same time, with the fire resistance of the polyurethane, a structure with high fire resistance is obtained. Thanks to this material, which is lightweight and has high fire resistance, the components located at the underbody of the vehicles are protected against various impacts, thus providing a safer drive. However, the sound isolation issue, which is one of the most important demands of vehicle manufacturers and which felt and polyurethane can provide at a very good level alone, is raised to a very high level by combining the two components.

1. A composite under-vehicle protection with phenolic felt content, characterized by comprising a polyurethane material which is applied by spraying on the said phenolic felt so as to form the said composite structure as rigid and integral.

2. The composite under-vehicle protection according to claim 1, wherein said polyurethane material is a filling material consisting of at least one of calcite, barite, and zeolite.

3. The composite under-vehicle protection according to claim 1, wherein the use ratio of phenolic felt in the said composite structure is between 60-90% and preferably 75%.

4. The composite under-vehicle protection according to claim 1, wherein the use ratio of polyurethane in the said composite structure is between 10-40% and preferably 25%.

5. The composite under-vehicle protection according to claim 1, wherein the use ratio of at least one of the mentioned calcite, barite, and zeolite is between 5-35% of the said polyurethane content and preferably 5%.

6. A production method of under-vehicle protection using phenolic felt which is cut in appropriate sizes and placed in shaping molds, characterized by comprising of the following steps:
a) spraying polyurethane material without filling material or by adding calcite, barite, and zeolite filling materials to create a homogeneous distribution on the phenolic felt surface placed in forming molds,
b) shaping/forming the sprayed polyurethane material and phenolic felt under temperature and pressure in press molds to provide a composite structure which is rigid and integral,
c) removing the formed composite structure from the molds and resting it.

7. The production method of under-vehicle protection according to claim wherein the temperature of the press mold in the said step (b) is preferably between 60-200° C.

8. The production method of under-vehicle protection according to claim 6, wherein the pressure in the press mold in the said step (b) is preferably applied as 250-450 tons for 30 seconds to 5 minutes.

9. The production method of under-vehicle protection according to claim 6, wherein the resting process in the said step (c) is preferably performed for 3 to 12 hours.
